(19) United States
(12) Patent Application Publication
(10) Pub. No.: US 2012/0157893 A1
(43) Pub. Date: Jun. 21, 2012

(54) Female masturbation device

(76) Inventor: Cun Yun Fang, Hong Kong (CN)

(21) Appl. No.: 13/248,035

(22) Filed: Sep. 29, 2011

(30) Foreign Application Priority Data
Dec. 21, 2010 (CN) 201010598669.7

(51) Int. Cl. A61H 7/00; A61H 19/00

(52) U.S. Cl. 601/11; 600/38

(57) ABSTRACT

A female masturbation device includes a casing, a flexible cup body, a flexible piston, a slide bar, a silica-gel rod and a driver. An exterior wall of a lower end portion of the casing is connected with an upper end of the flexible cup body and an upper end of the flexible piston from the top down in turn. The flexible piston is provided within the flexible cup body forming a negative pressure region between the flexible piston and the flexible cup body. The slide bar passes through the flexible piston, an upper end of the slide bar is connected with the driver, and a lower end of the slide bar is tightly fastened with an upper end of the silica-gel rod. The flexible cup body has a through hole, an arched convergence part and an annular bottom ring. The female masturbation device has the obvious masturbation effect on female.

### BACKGROUND OF THE PRESENT INVENTION

1. Field of Invention

The present invention relates to health care appliances, and more particularly to a female masturbation device.

2. Description of Related Arts

With the acceleration of the life rhythm, the female masturbation demand is increased. Existing female masturbation devices mostly use the vibration or twitching of the silica-gel rod. To increase the friction, the silica-gel rod usually has a very large size, so that not only the human organs are easy to be injured and the masturbation effect is not satisfactory, but also the interest in a real person is reduced after long-term use.

### SUMMARY OF THE PRESENT INVENTION

An object of the present invention is to provide a female masturbation device which has the obvious masturbation effect on women.

Accordingly, in order to accomplish the above object, the present invention provides a female masturbation device, comprising a casing having a hollow body, a flexible cup body, a flexible piston, a slide bar, a silica-gel rod and a driver,

wherein an exterior wall of a lower end portion of the casing is connected with an upper end portion of the flexible cup body and an upper end portion of the flexible piston from the top down in turn,

wherein the flexible piston is provided within the flexible cup body forming a negative pressure region between the flexible piston and the flexible cup body,

wherein the driver, adapted for providing the slide bar with power, is provided within the casing,

wherein the slide bar passes through the flexible piston and is tightly fastened therewith, an upper end of the slide bar is connected with the driver, a lower end of the slide bar is tightly fastened with an upper end of the silica-gel rod,

wherein the flexible cup body has a through hole provided at a central part of a lower end thereof, an arched convergence part, having a W-shape and bending towards the through hole, formed at a lower end portion of the flexible cup body, and an annular bottom ring surrounding a peripheral edge of the arched convergence part,

wherein the slide bar comprises a transversely convex edge provided at a position where the slide bar passes through the flexible piston, and a valve device provided on the transversely convex edge,

wherein the silica-gel rod passes through the through hole forming a non-tight joint therebetween.

Preferably, the lower end of the casing is threadedly connected with the upper end of the flexible cup body.

Preferably, a convex sealing ring is provided at the upper end of the flexible cup body.

Preferably, the lower end of the casing is snap-connected with the upper end of the flexible piston, and the sealing ring is provided on an exterior wall of the upper end of the flexible piston.

Preferably, the lower end of the slide bar is threadedly connected with the upper end of the silica-gel rod.

Preferably, the valve device comprises a ventilation hole through the transversely convex edge and a valve movably fitted on the ventilation hole.

Preferably, a control box, adapted for controlling an operation of the driver, is provided.

Preferably, a handrail is provided on the casing, which is convenient for the user to hold the female masturbation device of the present invention to contact with the related treatment sites of the human body.

The operation principle of the female masturbation device of the present invention is described as follows.

While using, the flexible cup body is attached to the human organ, the control box controls the rotate speed of the driver, the driver drives the slide bar to move up and down. When the slide bar moves upwardly, the ventilation hole is closed by the valve, a negative pressure region is formed between the flexible piston and the flexible cup body, the flexible cup body deforms to contract inwardly, so that the dynamically negative pressure massage to the human organ is produced. Under the effect of the varying negative pressure, the annular bottom ring of the flexible cup body moves up and down along the human body part, the direction of movement of the annular bottom ring is opposite to the direction of movement of the silica-gel rod, thus the negative pressure torus, which is capable of moving up and down, is produced. When the negative pressure torus moves upwardly, the contact surface of the flexible cup body and the human body is enlarged, and the negative pressure and the negative pressure torus are increased. Contrarily, the contact surface of the flexible cup body and the human body is reduced, and the negative pressure and the negative pressure torus are decreased. When the slide bar moves downwardly, the air pressure between the flexible piston and the flexible cup body is increased, the valve is open, and the airflow is vented via the ventilation hole. Repeat work as mentioned above. The handrail is adapted for holding the device of the present invention.

Compared with the prior art, the beneficial effects of the present invention are described as follows. Firstly, by the negative pressure generated by the movement of the flexible piston, the dynamically negative pressure massage to the vaginal area of the human body is produced via the bottom of the flexible cup body. The generated negative pressure ring, which is capable of moving up and down, greatly increases the friction between the human organ and the silica-gel rod, so that the silica-gel rod with the smaller size is used instead of the silica-gel rod with the larger size, which is in favor of protecting the human organ. The negative pressure ring, which is capable of moving up and down and produced by the contact ring point of the annular bottom ring of the flexible cup body, give a dynamically negative pressure massage to the vaginal part, so that the hormone secretion is increased and the mechanism of the human body is adjusted. Therefore, the female masturbation device of the present invention has the obvious masturbation effect on women. Secondly, the product is convenient for disassembling, cleaning and using.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a female masturbation device according to a preferred embodiment of the present invention.

FIG. 2 is a perspective view of a valve device.

FIG. 3 is a top view of FIG. 2.

In the drawings, 1: casing; 2: control box; 3: slide bar; 31: valve; 32: ventilation hole; 33: transversely convex edge; 34: screw; 4: flexible cup body; 41: through hole; 42: sealing ring; 43: arched convergence part; 44: bottom ring; 5: flexible piston; 6: silica-gel rod; 7: handrail; 8: negative pressure region.

### DETAILED DESCRIPTION OF THE PREFERRED EMBODIMENT

The present invention is further explained in detail with the accompanying drawings.

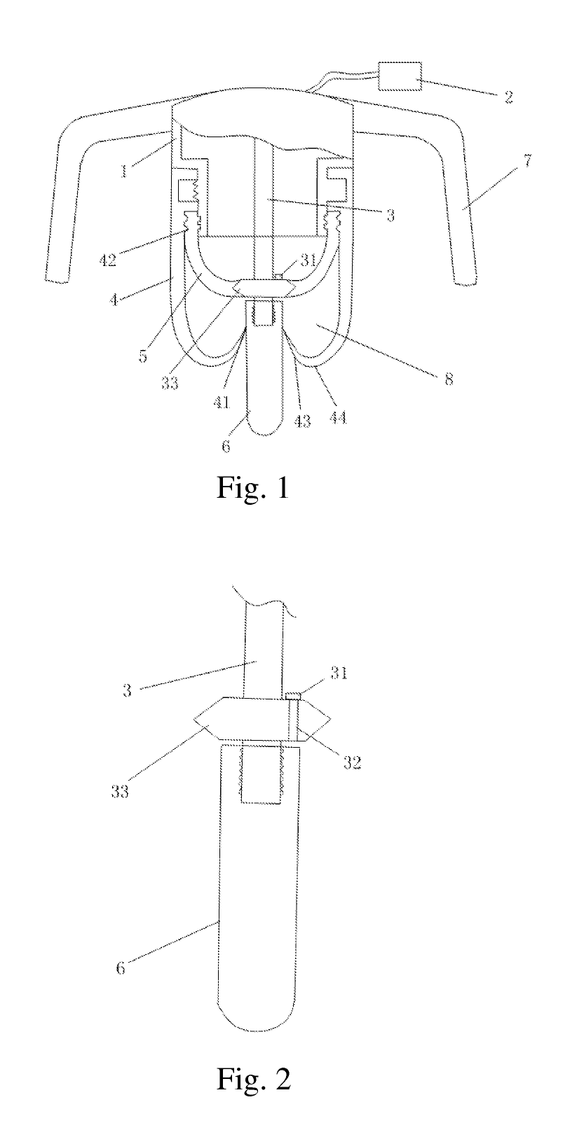

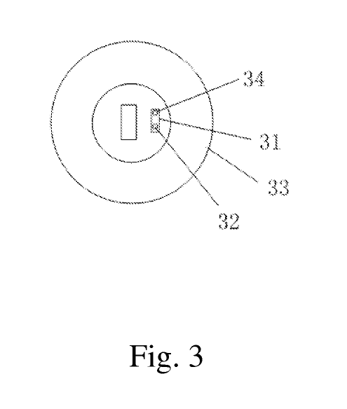

Referring to FIGS. 1 and 2 of the drawings, a female masturbation device according to a preferred embodiment of the present invention is illustrated, wherein the female masturbation device comprises a casing 1, a flexible cup body 4, a flexible piston 5, a slide bar 3, a silica-gel rod 6 and a driver. The casing 1 has a hollow body. The driver, provided within the casing 1, comprises a motor and a transmission device. The transmission device changes the rotation of the motor to the reciprocating translatory motion for driving the slide bar 3 to move up and down.

An exterior wall of a lower end portion of the casing 1 is connected with an upper end portion of the flexible cup body 4 and an upper end portion of the flexible piston 5 from the top down in turn. The flexible piston 5 is provided within the flexible cup body 4 and a negative pressure region 8 is formed between the flexible piston 5 and the flexible cup body 4.

The driver is adapted for providing the upright slide bar 3 with the power. An upper end of the slide bar 3 is connected with the driver. A lower end of the slide bar 3 passes through the flexible piston 5 and is tightly fastened therewith. The lower end of the slide bar 3 is tightly fastened with an upper end of the upright silica-gel rod 6.

A through hole 41 is provided at a central part of a lower end of the flexible cup body 4. The position where the through hole 41 is provided is elevated such that an arched convergence part 43, having a W-shape and bending towards the through hole 41, is formed at the lower end portion of the flexible cup body 4. Furthermore, the bottom edge of the arched convergence part 43 protrudes downwardly to form an annular bottom ring 44.

The silica-gel rod 6 passes through the through hole 41 forming the non-tight joint therebetween.

A transversely convex edge 33 is provided at a position where the slide bar 3 passes through the flexible piston 5. A valve device is provided on the transversely convex edge 33.

The lower end of the casing 1 is threadedly connected with the upper end of the flexible cup body 4.

A convex sealing ring 42 is provided at the upper end of the flexible cup body 4.

The lower end of the casing is snap-connected with the upper end portion of the flexible piston 5. The sealing ring 42 is provided on an exterior wall of the upper end portion of the flexible piston 5.

The lower end of the slide bar 3 is threadedly connected with the upper end of the silica-gel rod 6.

The valve device comprises a ventilation hole 32 through the transversely convex edge 33 and a valve 31 movably fitted on the ventilation hole 32. The valve 31, having a cover-shape, is capable of movably covering the ventilation hole 32. The valve 31 is fastened to the transversely convex edge 33 by a screw 34.

A control box 2 is provided for controlling the operation of the driver. The control box 2 is located outside the casing 1 to convenient for user's operation.

A handrail 7 is provided on the casing 1, so that while using, it is convenient for the user to hold the present invention to contact with the related treatment sites of the human body.

The flexible cup body 4 and the flexible piston 5 can be made of rubber or silica gel.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A female masturbation device, comprising:
a casing having a hollow body, a flexible cup body, a flexible piston, a slide bar, a silica-gel rod and a driver,
wherein an exterior wall of a lower end portion of said casing is connected with an upper end of said flexible cup body and an upper end of said flexible piston from the top down in turn,
wherein said flexible piston is provided within said flexible cup body forming a negative pressure region between said flexible piston and said flexible cup body,
wherein said driver, adapted for providing said slide bar with power, is provided within said casing,
wherein said slide bar runs through said flexible piston and is tightly fastened therewith, an upper end of said slide bar is connected with said driver, a lower end of said slide bar is tightly fastened with an upper end of said silica-gel rod,
wherein said flexible cup body has a through hole provided at a central part of a lower end thereof, an arched convergence part, having a W-shape and bending towards said through hole, formed at a lower end portion of said flexible cup body, and an annular bottom ring surrounding a peripheral edge of said arched convergence part,
wherein said slide bar comprises a transversely convex edge provided at a position where said slide bar passes through said flexible piston, and a valve device provided on said transversely convex edge.

2. The female masturbation device, as recited in claim 1, wherein said lower end of said casing is threadedly connected with said upper end of said flexible cup body.

3. The female masturbation device, as recited in claim 1, further comprising a sealing ring provided at the upper end of said flexible cup body.

4. The female masturbation device, as recited in claim 2, further comprising a sealing ring provided at the upper end of said flexible cup body.

5. The female masturbation device, as recited in claim 3, wherein said lower end of said casing is snap-connected with said upper end of said flexible piston, said sealing ring is provided on an exterior wall of said upper end of said flexible piston, such that said upper end of said flexible cup body and said upper end of said flexible piston are sealed.

6. The female masturbation device, as recited in claim 4, wherein said lower end of said casing is snap-connected with said upper end of said flexible piston, said sealing ring is provided on an exterior wall of said upper end of said flexible piston, such that said upper end of said flexible cup body and said upper end of said flexible piston are sealed.

7. The female masturbation device, as recited in claim 1, wherein said lower end of said slide bar is threadedly connected with said upper end portion of said silica-gel rod.

8. The female masturbation device, as recited in claim 2, wherein said lower end of said slide bar is threadedly connected with said upper end portion of said silica-gel rod.

9. The female masturbation device, as recited in claim 3, wherein said lower end of said slide bar is threadedly connected with said upper end portion of said silica-gel rod.

10. The female masturbation device, as recited in claim 4, wherein said lower end of said slide bar is threadedly connected with said upper end portion of said silica-gel rod.

11. The female masturbation device, as recited in claim 5, wherein said lower end of said slide bar is threadedly connected with said upper end portion of said silica-gel rod.

12. The female masturbation device, as recited in claim 6, wherein said lower end of said slide bar is threadedly connected with said upper end portion of said silica-gel rod.

13. The female masturbation device, as recited in claim 1, wherein said valve device comprises a ventilation hole through said transversely convex edge and a valve movably fitted on said ventilation hole.

14. The female masturbation device, as recited in claim 3, wherein said valve device comprises a ventilation hole through said transversely convex edge and a valve movably fitted on said ventilation hole.

15. The female masturbation device, as recited in claim 1, further comprising a control box adapted for controlling an operation of said driver, located outside said casing.

16. The female masturbation device, as recited in claim 3, further comprising a control box adapted for controlling an operation of said driver, located outside said casing.

17. The female masturbation device, as recited in claim 1, further comprising a handrail provided on said casing 1.

18. The female masturbation device, as recited in claim 3, further comprising a handrail provided on said casing 1.

19. The female masturbation device, as recited in claim 1, wherein said flexible cup body and said flexible piston are made of rubber or silica gel.

20. The female masturbation device, as recited in claim 3, wherein said flexible cup body and said flexible piston are made of rubber or silica gel.
